(19) United States
(12) Patent Application Publication
(10) Pub. No.: US 2009/0134350 A1
(43) Pub. Date: May 28, 2009

(54) DISENGAGEABLE SPINDLE DRIVE

(76) Inventor: David John Ammunson, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/162,659

(22) PCT Filed: Jan. 30, 2007
(86) PCT No.: PCT/AU2007/000080

§ 371 Date: Nov. 18, 2008

(30) Foreign Application Priority Data
Jan. 30, 2006 (AU) 2006900426

(51) Int. Cl. F16K 5/00; F16D 1/108

(52) U.S. Cl. 251/304; 74/814

(57) ABSTRACT

A shaft drive arrangement including a drive member (402), a driven shaft (100); a disengageable drive mechanism, (202, 204, 302), adapted to connect the shaft and drive member, the mechanism including one or more engagement recesses (304) and one or more engagement members (202, 204), each engagement member being adapted to cooperate with an engagement recess; and a disengagement member (312) adapted to disengage the or each engagement member from the engagement recess with which it is engaged.

### TECHNICAL FIELD

This invention relates to disengaging mechanisms for rotary shafts such as tap valve stems.

### BACKGROUND

There is a need to provide a means for disengaging a drive member from a driven shaft. In particular, young children can turn taps on and leave them running, which wastes water. This can also potentially lead to water damage where a plug is in the basin or bath. It may also cause a risk of scald injury.

It is therefore desirable to provide a disengaging mechanism which is difficult for young children to overcome, but which can be readily operated by an adult or older child.

### DISCLOSURE OF THE INVENTION

This invention proposes a shaft drive arrangement including:
a drive member,
a driven shaft;
a disengageable drive mechanism adapted to connect the shaft and drive member;
the mechanism including one or more engagement recesses and one or more engagement members;
each engagement member being adapted to cooperate with an engagement recess; and
a disengagement member adapted to disengage the or each engagement member from the engagement recess with which it is engaged.

The engagement recess can be connected to the shaft and the engagement member can be connected to the drive member.

The engagement member can be connected to the shaft and the engagement recess can be connected to the drive member.

The engagement member can be a pivoted arm.

The disengagement member can be a cylinder surrounding the shaft and adapted to move parallel to the axis thereof to contact the engagement member and cause it to pivot out of engagement with the engagement recess.

The engagement member can be resiliently biased.

The engagement member can be magnetically biased.

The engagement member can be gravitationally biased.

The shaft drive arrangement can include a retaining means to retain the clutch in the disengaged position when not in use.

The disengagement member can be gravitationally biased.

The disengagement member can be spring biased.

The disengagement member can be magnetically biased.

The disengagement member can be biased to the disengaged state.

The shaft can be the valve operating shaft.

The drive arrangement can be arranged to prevent operation of the valve when the drive is disengaged.

### BRIEF DESCRIPTION OF THE DRAWINGS

FIG. 1 shows a partial view of the spindle of a tap adapted for use in an embodiment of the invention.

FIG. 2 shows an embodiment of engagement members suitable for use with the spindle of FIG. 1.

FIG. 3 shows an exploded view of the main elements of a disengageable clutch arrangement according to an embodiment of the invention.

FIG. 4 shows a handle assemble suitable for use with the embodiment of the invention shown in FIG. 3.

FIG. 5 shows a disengagement element adapted for use with the embodiment of FIG. 3.

FIG. 6 shows a spindle arrangement including a guide surface adapted for use with the disengagement element of FIG. 5.

FIG. 7 shows an alternative embodiment, with the engagement element connected to the handle.

FIG. 8 shows a spring loaded version of the engagement elements.

FIG. 9A shows the tap in the disengaged state.

FIG. 9B shows the tap in the engaged state.

FIG. 10 shows an alternative embodiment of the invention.

FIG. 11 shows an exploded view of the embodiment of FIG. 10.

FIG. 12 shows detail of the lug assembly of FIG. 10.

FIG. 13 shows a further embodiment of the invention;

FIG. 14 shows an alternative arrangement for retaining the magnets.

### DESCRIPTION OF THE EMBODIMENTS OF THE INVENTION

The invention will be described with reference to the embodiments shown in the drawings.

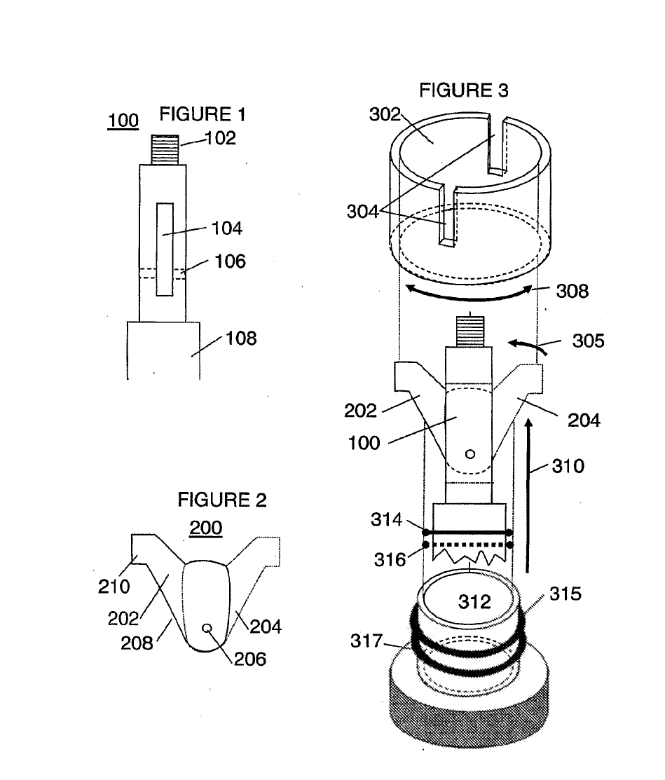

FIG. 1 shows a partial view of the spindle 100 of a tap adapted for use in an embodiment of the invention. The spindle has a stepped extension 102 which may be used to mount a handle. Extension 102 may be threaded to mount a cap which may indicate, whether the tap is for hot or cold water. A slot 104 is provided through the spindle, and a pivot hole 106 is drilled transverse to the slot. the body of the valve operating mechanism can be a standard valve operating mechanism, and is indicated generally by the open rectangle 108.

FIG. 2 shows an embodiment of engagement means 200 adapted for use with the spindle of FIG. 1. A pair of engagement members 202, 204 are mounted back-to-back. Engagement member 204 is shown in ghost to distinguish it from engagement member 202. Each engagement member has a pivot hole and these are aligned at 206.

Each engagement member has an angled edge 208 and a latching protrusion 210.

As shown in the exploded view of FIG. 2, the engagement members 202, 204 are mounted in slot 104 via a pivot pin inserted through holes 106, 206. The engagement members 202, 204 can be free to rotate about the pivot pin independently of each other, or they can be spring biased as shown in FIG. 8.

The engagement members 202, 204 maybe designed so that, in the retracted position, they have their centres of gravity “outside” a vertical line through the pivot point 206 to provide a gravitational bias causing the free ends to tend to fall outward from the spindle.

Referring to FIG. 3, disengagement element 312 is adapted to fit over spindle 100 and, when assembled, is located below the engagement members. The collar 312 may be a sliding fit over the cylindrical body 108, or grommet or O-ring 314 may be provided to provide a sliding fit. There may be more than one O-ring as shown at 316. Additional O-rings 315, 317 can be provided, seated in O-ring grooves on the outer surface of the disengagement member 312.

Disengagement element 312 is adapted to be slid up parallel to the axis of spindle 100 as shown by arrow 310, and engage with the angled edges 208 of the engagement members. Further sliding of the disengagement element 312 forces the engagement elements 202, 204 back into the recess 104.

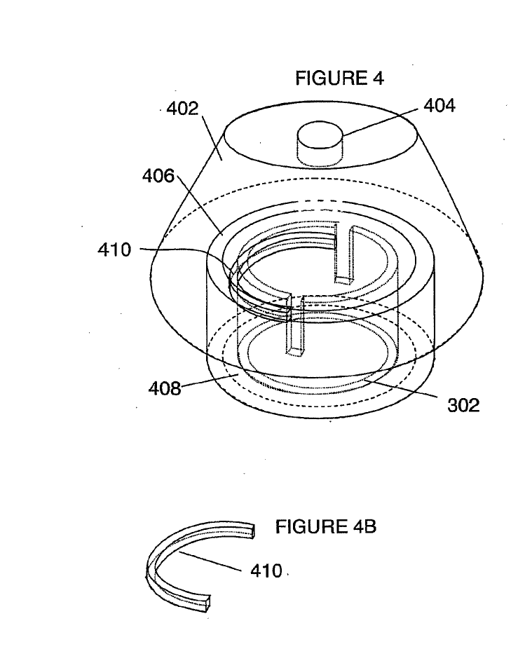

A pair of engagement recesses 304 are provided in engagement collar 302. Engagement collar 302 is connected to handle 402 as shown in FIG. 4. When the disengagement element 312 is slid down and disengaged from the engagement members 202, 204, the engagement members 202, 204 are biased to pivot so the latching ends 210 move in an arc centred on the pivot 206, the movement having a radial component which causes the latching ends 210 to contact the wall of engagement collar 302. Because the engagement collar 302 is attached to the handle, when the handle is turned, the engagement collar 302 also turns as indicated by arrow 305. Within half a turn, the engagement recesses 304 will align with the latching projections 210 and the latching projections will engage with the recesses under the operation of the outward bias. When this occurs, the tap can be operated normally as the action of turning the tap is applied to the shaft 100 via the engagement members 202, 204. More than two engagement recesses can be provided around the engagement collar so that the maximum lag between turning the handle and the shaft 100 beginning to turn is less than half a turn.

As seen in FIG. 4, the handle 402 includes hollow bushing 404 to permit the handle to rotate around the end 102 of spindle 100. Engagement collar 302 and a cylindrical bushing 406 are connected to the handle 402, for example by being welded or otherwise joined to a disc shaped plate (not shown) at the bottom of the handle 402. The bush 404 leaves the threaded end of the spindle accessible for a cap or branded “button” to be screwed to the spindle. Alternatively, the outer surface of the end of the spindle can be smooth. In a further modification the end of the spindle can be internally threaded. Alternatively, an indicator cap can be fitted to the handle as a press fit or screw thread attachment, in which case, the cap will include an internal bore adapted to permit free rotation around the end of the spindle.

Bushing 406 is concentric with engagement collar 302, and can have a larger inside diameter than the outside diameter of collar 302, resulting in an annular gap 408.

In one embodiment, the outward bias applied to the engagement members 202, 204 can be supplied by a magnet where the engagement members are of a suitable magnetic material. As shown in FIG. 4, a “horseshoe” type magnet 410 is inserted into the gap 408 with the ends of the magnet 410 near the recesses 304. The magnet can be fixed in place by any suitable means including gluing. Alternatively, a circlip may be used. The circlip should preferably be of non-magnetic material or of high reluctance to avoid excessive diversion of the magnetic field away from the engagement members 202, 204. As the engagement members are of a magnetic material, they form part of a magnetic circuit between the poles of the magnet. FIG. 4B shows detail of the horseshoe magnet 410.

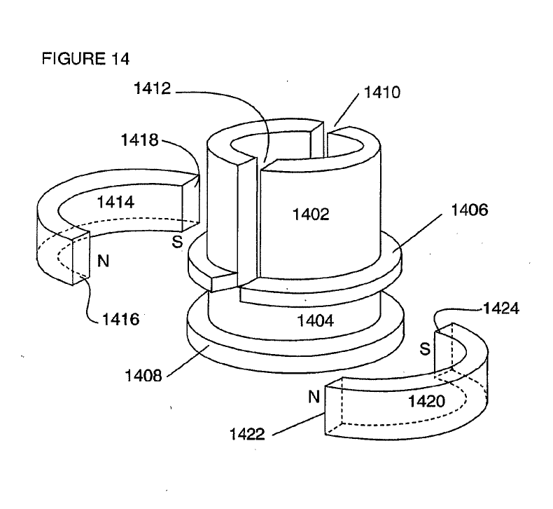

In an alternative embodiment shown in FIG. 14, the engagement member 1402 includes a pair of peripheral rims 1406, 1408 defining a circumferential groove 1404 adapted to receive one or two horseshoe type magnets 1414, 1420. The magnets 1414, 1420 are inserted into groove 1404 with their matching poles 1416, 1422 opposed, i.e., north pole to north pole aligned with the slots 1410, 1412 through which the engagement members pass. The inner wall of the cylinder 406 holds the magnets 1414, 1420 in place. This arrangement avoids the need to fix the magnets in place by gluing or with a circlip, etc.

Other magnet configurations can also be used. It is not necessary for the same magnet to be used for each engagement member. Thus separate magnets can be used in proximity to the recesses 304, or otherwise arranged to provide a magnetic field in the region of the recesses 304.

When it is desired to decouple the handle 402 from the shaft 100, the disengagement member 312 is slid up to contact the engagement members 202, 204 and force them back at least partly into the slot 104 as indicated by arrow 308 so that the latching ends 210 become disengaged from the recesses 304.

Disengaging member 312 fits freely within, or is a sliding fit within collar 302.

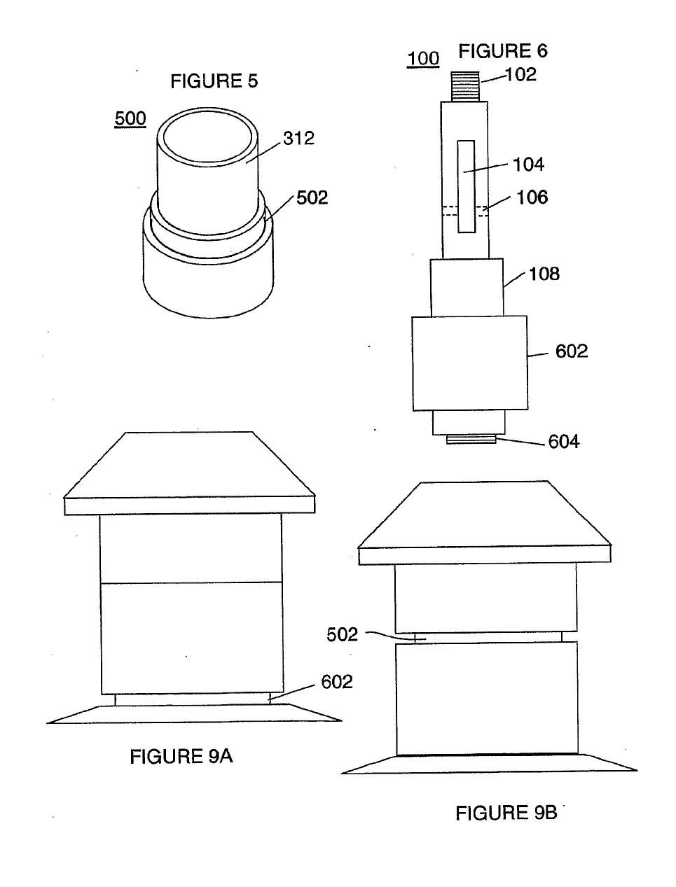

FIG. 5 shows a clutch arrangement 500 for mounting the disengagement collar 312. An external bushing 504 is provided for a user to grip when engaging or disengaging the shaft. This can be provided with a knurled surface. An intermediate cylindrical step 502 can be provided between the external bushing 504 and the disengaging collar 312.

The external bushing 504 is adapted to be a light friction fit over the guide surface of guide cylinder 602 shown in FIG. 6 so that the bushing 504 will slide smoothly and without the need for excessive force. Preferably the surface is a low friction surface.

The intermediate step 502 can form part of a magnetic latch arrangement adapted to engage with a latching magnet in the lower end of the handle bushing 406. For example, a washer type magnet may be provided in the gap 408 between the bushing 406 and engagement collar 302.

Alternative latching arrangements may be used. As described above, the bushing 504 may be a friction fit over the guide surface of the cylindrical guide 602. Alternatively, a twist latch arrangement with a projecting pin on the inner wall of the bushing 406 engaging in a slot I the intermediate step 502.

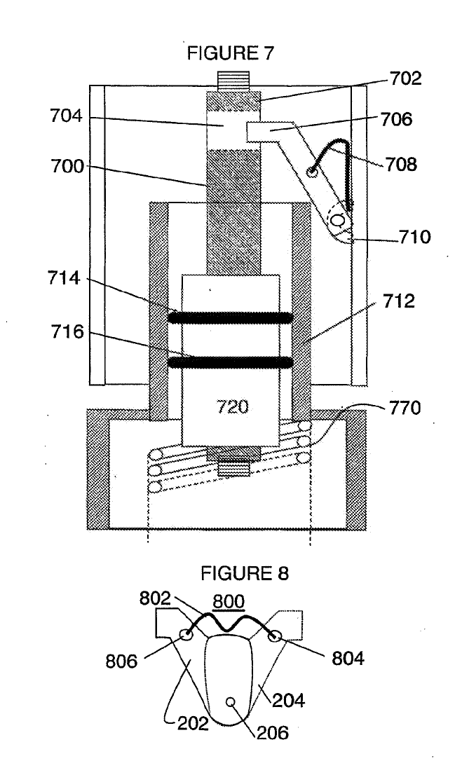

FIG. 7 shows an alternative arrangement in which the engaging member 706 is mounted on the inner wall of bushing 406, and engages with a slot 704 in stem 702. A spring 708 biases the engagement member 706 towards the slot 704. The disengagement collar 712 can be slid upwards to disengage the engagement member from slot 704.

Instead of slot 704, a cross-arm may be provided attached to spindle 700 to engage the engaging member 706.

A bias spring 770 can be provided to urge the disengagement member 712 into the disengaged position. The top of the spring acts on the disengagement member 712, while the other end of the spring acts against the tap housing (not shown). Thus the disengagement member can be manually operated by pushing it against the spring to turn the tap on or off, and, when the hand force is removed, the disengagement member 712 will return to the disengaged position, with the drive members 706 disengaged from the slot 704. This bias spring arrangement can also be utilized with the embodiment shown in FIG. 3, with the engagement members mounted on the spindle.

FIG. 8 shows an arrangement in which the engagement members 202, 204 are spring biased by spring 802 to force their latching ends towards the engagement collar 302.

FIG. 9A shows an external view of a tap in the disengaged condition. The control bush 504 which carries the disengagement collar 312 is in the upward position and in contact with the lower edge of bushing 406. This means that the engagement members 202, 204 are pushed back into the slot 104 by the disengagement collar 312. Thus the handle 402 is disconnected from shaft 100.

In FIG. 9B the control bush 504 is in its lower position so that the disengagement collar is lowered to permit the engagement members 202, 204 to extend out to the engagement collar 302 under the bias action which may be, for example, magnetic, gravitational, or spring bias.

The clutch mechanism 500 can be designed to slide over the supporting surface 602 only if an axial force is applied without significant transverse force. The mounting can be arranged to jam while a transverse force is applied. Taps incorporating the invention provide a means of preventing the use of the tap by very young children. Thus taps cannot be turned on by an unsupervised child.

The inventive taps can also be used to set the temperature of the water from a tap where the hot and cold water flows are mixed. When the flow has been set to the desired temperature, the taps can be disengaged.

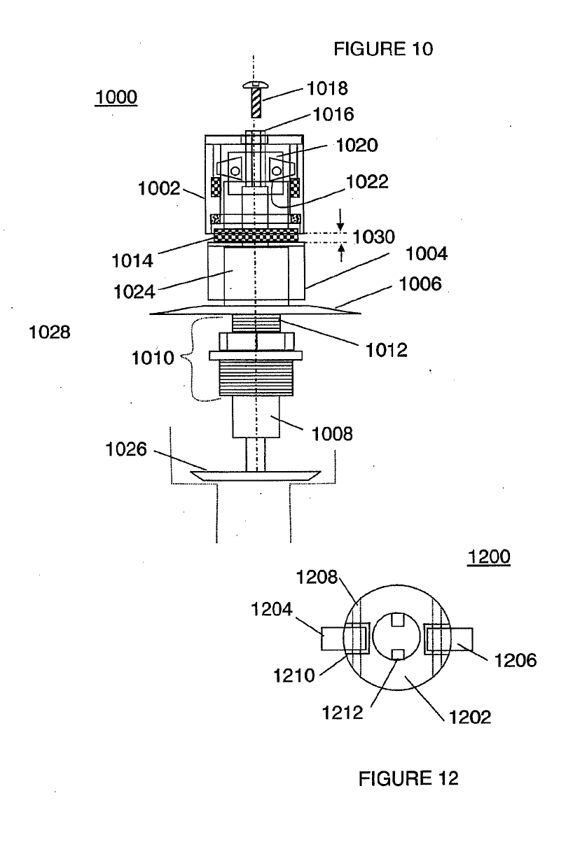

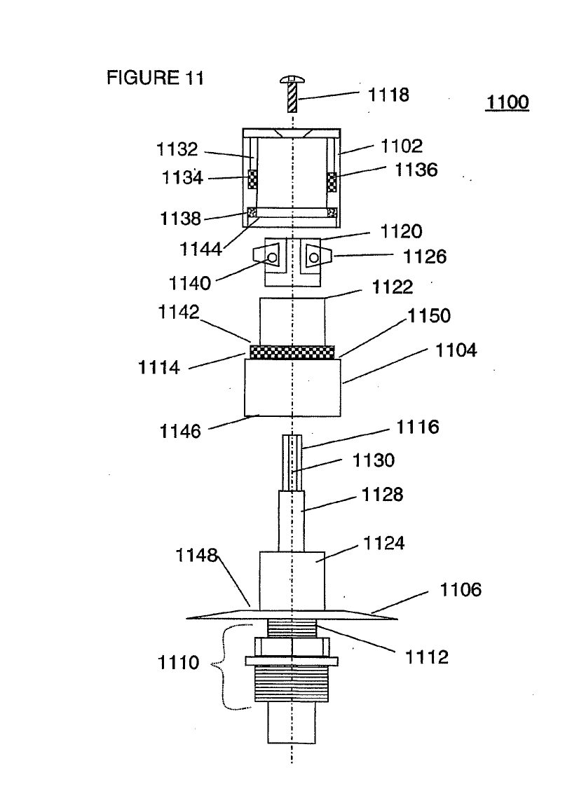

An alternative embodiment of the invention will be described with reference to FIGS. 10, 11, and 12, which show the internal detail of a tap 1000. This embodiment uses a collar 1020 to carry the engagement lugs 1022. The collar and lugs are described in more detail with reference to FIG. 12. The tap handle (not shown) is connected to the outer cylindrical “clutch plate” 1002. Clutch plate 1002 includes slots 1132 (FIG. 11) to engage with the lugs 1022. Magnet actuators 1134 serve to draw the lugs 1022 into slots 1132 when the inner clutch plate 1004 is in the lowered position and the upper rim 1022 permits the lugs to engage with the slots. The lower edge of the clutch lugs 1126 presents a camming surface to the inner clutch rim 1122. FIG. 10 shows the clutch plate 1004 in the lowered position with a gap 1030 between the step 1150 (FIG. 11) and the bottom of outer clutch plate 1002. This is the engaged position with the rim 1022 lowered to permit the logs to be drawn outwards and into the slots 1132.

In the disengaged position, the inner clutch plate 1004 is drawn up to contact the lower rim of upper plate 1002 by magnet 1014. A “soft” magnetic ring 1138 assists the magnetic attraction between clutch plates 1002 and 1004. The upper and lower clutch plates are dimensioned so that, in the disengaged state, there is an air gap between the magnet 1014 and the ring 1138. Alternatively, a non-magnetic washer can be used between the magnet 1014 and the ring 1138.

As shown in FIG. 12, the collar 1200 is in the form of an annulus 1202 with internal lugs 1212. The clutch lugs 1204, 1206 are located in slots 1210 and pivot around pins 1208. The clutch lugs 1204, 1206 are of a soft magnetic material. The collar 1202 can also be of a magnetic material. In the disengaged position, the clutch lugs can protrude slightly beyond the outer circumference of the collar 1202 to provide a lower the magnetic reluctance path from the magnets 1134, 1136 through the clutch lugs. In one embodiment, the magnets 1134, 1136 are arranged in anti-parallel physically, e.g., magnet 1134 has its North pole pointing upwards, and magnet 1136 has its North pole pointing down. This results in an additive magnetic path.

In the exploded view of FIG. 11, the tap spindle is attached to the handle and the associated outer clutch plate 1102 by screw 1118 which prevents axial movement between the spindle and the handle, but does not provide rotary connexion. Thus the handle is free to turn on the spindle unless the clutch lugs 1126 engage in the slots 1132. The locating lugs 1212 of the collar 1120 engage in a slot 1130 of the spindle 1116. The upper part of spindle 1116 can be of reduced diameter and the step in the spindle diameter 1126, 1124 can provide an axial travel stop for the collar 1120.

The collar 1120 can be attached to the spindle by any suitable means, such as by a screw thread connexion.

Where the tap is a wall mounted tap, the fairing 1106, 1124 provides an adjustment means which permits adjustment of the tap travel to seat the valve 1026 in the valve seat. The fairing can also be used to adjust the travel of the inner clutch plate to operate the clutch lugs.

Various configurations of magnets and magnetic paths are possible without departing from the spirit of the invention. In one embodiment, a pair of magnets may be used in place of the three magnets shown in FIG. 10. For example, the magnets 1134, 1136 can also be used to provide both the magnetic actuation for the clutch lugs 1204, 1206 and to operate the inner and outer clutch plates 1004, 1002. The soft magnetic ring 1138 can be discarder, and magnets 1134, 1136 can be extended down to the position previously occupied by the bottom of the ring 1138, and magnet 1114 can be replaced by a soft magnet ring.

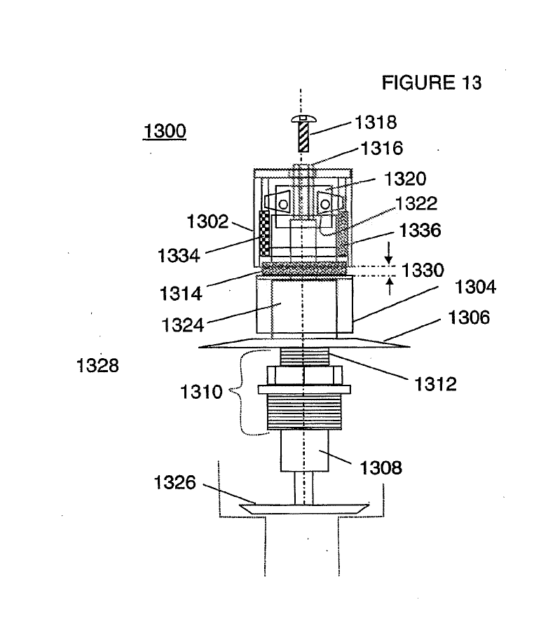

In a further embodiment shown in FIG. 13, a single magnet, such as 1334 can be used to provide all the magnetic actuation. The other magnet can be replaced by a soft magnetic arm 1136.

The invention is also applicable to mixing taps, and can be applied to engage and disengage the temperature setting control mechanism.

While the invention has been described with reference to a number of specific integers, it will be apparent that the invention extends to alternative combinations and to equivalent integers.

1. A shaft drive arrangement including:
a drive member;
a driven shaft;
a disengageable drive mechanism adapted to connect the shaft and drive member;
the mechanism including one or more engagement recesses and one or more engagement members;
each engagement member being adapted to cooperate with an engagement recess;
and a disengagement member adapted to disengage the or each engagement member from the engagement recess with which it is engaged.

2. A shaft drive arrangement as claimed in claim 1, wherein the engagement recess is connected to the shaft and the engagement member is connected to the drive member.

3. A shaft drive arrangement as claimed in claim 1, wherein the engagement member is connected to the shaft and the engagement recess is connected to the drive member.

4. A shaft drive arrangement as claimed in claim 1, wherein the or each engagement member is a pivoted arm.

5. A shaft drive arrangement as claimed in claim 1, wherein the disengagement member is a cylinder surrounding the shaft and adapted to move parallel to the axis thereof to contact the engagement member and cause it to pivot out of engagement with the engagement recess.

6. A shaft drive arrangement as claimed in claim 1, wherein the engagement member is resiliently biased.

7. A shaft drive arrangement as claimed in claim 1, wherein the engagement member is magnetically biased.

8. A shaft drive arrangement as claimed in claim 1, wherein the or each engagement member is gravitationally biased.

9. A shaft drive arrangement as claimed in claim 1 including a retaining means to retain the clutch in the disengaged position when not in use.

10. A shaft drive arrangement as claimed in claim 1, wherein the disengagement member is gravitationally biased.

11. A shaft drive arrangement as claimed in claim 1, wherein the disengagement member is spring biased.

12. A shaft drive arrangement as claimed in claim 1, wherein the disengagement member is magnetically biased.

13. A shaft drive arrangement as claimed in claim 1, wherein the disengagement member is biased to the disengaged state.

14. A tap including a shaft drive arrangement as claimed in claim 1, wherein the shaft is the valve operating shaft.

15. A tap including a shaft drive arrangement as claimed in claim 14, wherein the drive arrangement is arranged to prevent operation of the valve when the drive is disengaged.

16. A tap handle including a through hole adapted permit the tap handle to freely rotate around a tap spindle.

17. A mixing tap having a temperature control which is engagable and disengageable using the shaft drive arrangement as claimed in claim 1.

18. (canceled)

19. (canceled)
